(19) United States
(12) Patent Application Publication
(10) Pub. No.: US 2025/0201023 A1
(43) Pub. Date: Jun. 19, 2025

(54) Camera Recognition System for Function Activation

(71) Applicant: Vincent Loccisano, Wellesley, MA (US)

(72) Inventor: Vincent Loccisano, Wellesley, MA (US)

(21) Appl. No.: 19/063,910

(22) Filed: Feb. 26, 2025

(51) Int. Cl. G06V 40/20; G07C 9/37

(52) U.S. Cl. CPC G06V 40/20; G07C 9/37

(57) ABSTRACT

A system and method use predefined motions that can be programmed to activate relevant functions remotely. By recognizing these gestures through a camera-recognition system, a user can trigger a mechanical event even when their hands are occupied. The system and method employ cameras and sensors along with a processor application to record a predefined human motion. Once recorded and stored, the application monitors cameras and/or sensors to recognize the predefined motion as it is performed. Once recognized, the application engages electronic equipment to perform a mechanical function specific to the motion.

### TECHNICAL FIELD

The present disclosure relates generally to camera recognition systems, and more specifically to a system and method using camera and sensor detection and recognition technology for responding to body movements to activate specific functions. Some functions include unlocking a vehicle, opening a vehicle door; or unlocking or opening a home of office door or gate.

### BACKGROUND OF THE INVENTION

The operation of doors, gates and other similar access control mechanisms has seen a gradual evolution from purely manual methods to more automated and convenient systems. Mechanisms that require a physical interaction, such as turning handles, pushing levers, or sliding bolts have evolved into remote-controlled devices. The introduction of remote controls and keycard systems offered a significant improvement in convenience, allowing users to activate these mechanisms from a distance. Remote controls may be misplaced, or batteries may fail; keycards may be lost or stolen, posing a security risk.

Voice control is an alternative for activating doors, gates and other mechanisms. While offering hands-free operation, voice control can be unreliable in noisy environments or when privacy is a concern.

Gesture control presents a promising and intuitive alternative for activating doors, gates and similar mechanisms. By allowing users to activate such mechanisms through simple and natural gestures, gesture control offers a convenient solution that can be hands-free. Existing attempts at implementing gesture control for access control have faced several challenges. Early systems involved pre-programmed gestures, such as moving a foot under a bumper to open a trunk. These systems lacked accuracy and reliability, misinterpreting gestures or failing to recognize them consistently. Ambient lighting conditions, clothing, and individual variations in gesture execution negatively impacts the performance of these systems.

Another significant challenge lies in the design of intuitive and unambiguous gestures. Pre-programed gestures must be easily learned and remembered by users and must be distinct enough to avoid accidental activation.

Integrating gesture-control seamlessly with existing mechanisms presents a significant hurdle. A functioning system must be compatible with a wide range of locking mechanisms and control systems.

Rearview and side-view cameras, mounted on or near a rear license plate or under the side mirrors of a vehicle, are designed to monitor blind spots, and may be combined with forward-facing and rearview cameras to support surround-view systems. Surround-view systems combine images from multiple cameras to create a 360-degree top view of a vehicle and its surroundings. Side-view sensors measure the existence of objects rather than an image of them. Sensors are more accurate in detecting objects and function better than cameras in low light and foggy environments.

Most automotive cameras use Complimentary Metal-Oxide-Semiconductor (CMOS) image sensors, which are compact and energy-efficient. Some cameras and sensors use infrared technology to improve visibility in low-light conditions. Image-processing software may be used together with CMOS cameras to interpret images and extract relevant information, detecting objects, recognizing lanes and identifying traffic signs.

Bluetooth Low Energy (BLE) is a low-power wireless communication technology that uses transmitters and receivers to enable devices to communicate over short distances. Smart phones may be used as BLE transmitters. Near-field communication (NFC) is a short-range wireless communication technology that functions in devices in very close proximity, usually a few centimeters, to establish connection. Car-key fobs, also known as remote keyless entry (RKE), use radio-frequency (RF) signals to communicate, sending a signal to a vehicle's receiver to activate a vehicle start button.

Common sensors include driver-gesture detection, blind-spot and rear-view proximity sensors. These sensors detect the presence and distance of objects by emitting infrared light and detecting the reflected light to track the position and movement of objects. They can be used with cameras or independently. Infrared sensors are less susceptible to lighting conditions than cameras alone. Additional sensors may include wireless connectivity, sometimes referred to as Ultra-Wideband (UWB) and Bluetooth connections, to devices such as AirTags or mobile electronic devices such as phones, watches or tablets, of nearby passersby or vehicle operators. A combination of cameras and sensors provides reliable motion recognition in low-light, foggy, or other environments where cameras alone are insufficient.

Automobile electronics, including computers, electrical cables, and software protocols, are together known as a controller-area network (CAN), or CANbus. A CAN is a vehicle's main computer system. Through the CANbus, data travels through the system to the many subsystems such as those controlling the engine, the transmission, doors, windows, and other subsystems. Each of these subsystems is controlled by an electronic control unit (ECU). Current vehicles may have fifty or more ECUs, each able to sense signals indicating, for example: acceleration at various angles; voltage; pressure; braking; vehicle roll and yaw; steering angle; temperature, and other variables. The CANbus routes signals from sensors to computers as communicated by each ECU. An ECU can monitor voltage used by a subsystem and communicate that information through the CANbus to actuate, for instance, stopping a power-sliding door from closing on a passenger's limb, or adjusting a fuel injector's performance.

Adding to or changing a vehicle's electronic features once required extensive wiring. With the development of CAN, feature development has become physically easier because each new feature can now be added by programming new computer code into the CAN. Now, all vehicle features as well as vehicle diagnostics are controlled via CAN, which uses a standardized protocol called OBD-II. New features can be integrated into a vehicle by developing and uploading an algorithm into the vehicle's CAN.

Electromechanical actuators are components, used in a wide range of applications, that convert electrical energy into mechanical motion. These devices are employed in devices from robotics and automation systems to automotive components and consumer electronics. Electromagnetic actuators include solenoids and electric motors that generate linear or rotary motion. More advanced actuation technology includes piezoelectric and shape memory alloys and innovative designs such as micro-and nano-electromechanical systems (MEMS/NEMS) to create actuators with enhanced capabilities.

Electromechanical actuators may be configured to engage or disengage latches, locks and the like used in opening or closing doors, gates and the like in vehicles or buildings or may be configured to engage any electronic switch.

There remains a need for a robust, reliable and secure gesture-control system for opening vehicle doors, building doors, gates and similar mechanisms. Such a system should be accurate and reliable in various environments; recognize a wide range of gestures; be cost-effective; and integrate seamlessly with existing access-control systems.

### SUMMARY OF THE INVENTION

A system and method use predefined motions that can be programmed to activate relevant functions remotely. By recognizing these gestures through a camera-recognition system, a user can trigger a mechanical event even when their hands are occupied.

The system and method employ cameras and sensors along with a computer application to record a predefined human motion. Once recorded and stored, the application monitors cameras and/or sensors to recognize the predefined motion as it is performed. Once recognized, the application engages electronic equipment to perform a mechanical function specific to the motion.

In some embodiments, the predefined motion is a standard motion that is embedded in the application and may be performed by any individual. One skilled in the art is familiar with trunk doors that open when a foot is waved beneath a car bumper. In other embodiments a predefined motion may be recorded by cameras and/or sensors wherein the recording is processed by a processor and stored in an application. Predefined motions may involve waving a hand, nodding a head, moving any appendage, movement of hips, movement of shoulders, walking in a specific pattern, or any combination thereof. When the motion is recorded by an individual, cameras and sensors may be configured to recognize the size and shape of the individual as well as their predefined motion. With the predefined motion recorded, the application monitors cameras and/or sensors to recognize the predefined motion when it is performed in range of the cameras and/or sensors. With the predefined motion recognized, the application engages electronic equipment to perform a function. In some embodiments electromechanical actuators move a component to perform a function. In other embodiments the electronic equipment actuates a switch that may be configured to turn an electronic device on or off, or may move a solenoid to move a component such as a door or gate lock.

The system and method can be used to actuate automotive functions such as unlocking vehicle doors or trunks, starting an engine or turning lights on or off. It may be used in residential and commercial buildings to unlock doors, activate smart-home devices, or control access to secured areas through gates and elevators, for example. Industrial functions may include controlling access to secured areas, operating machinery or initiating safety protocols in high-security environments. In a healthcare facility, the system and method may enable hands-free access to restricted areas or may operate medical equipment. One skilled in the art understands that hands-free actuation of devices and equipment may improve hygiene by reducing physical contact with devices and equipment. In retail and warehouse situations, the system and method may manage access to storage areas, control inventory-control mechanisms, and streamline logistical operations by enabling hands-free engagement with logistical-operation mechanisms.

A processor receives signals from cameras and sensors through wired or wireless connectivity. The processor further receives signals from a personal electronic device through a wireless connectivity such as UWB, Bluetooth, or NFC. A personal electronic device may be a UWB sensor, mobile phone or tablet. A software application stored in the processor receives the signals from a personal electronic device and receives signals from cameras and/or sensors. The software application processes the signals from the personal electronic device to identify the person associated with it. One skilled in the art understands that it is assumed that the personal electronic device is in the possession of its owner. The software application then processes the signals from cameras and/or sensors to identify the predefined motion performed by the positively identified person. Once the electronic device is identified and the motion detected, the application engages electronic equipment to perform a related function. The specific function is related to the detected motion.

### BRIEF DESCRIPTION OF DRAWINGS

FIG. 1 is a diagram illustrating the system of the embodiment.

FIG. 2 is a diagram illustrating a method of using the system of FIG. 1.

### DETAILED DESCRIPTION

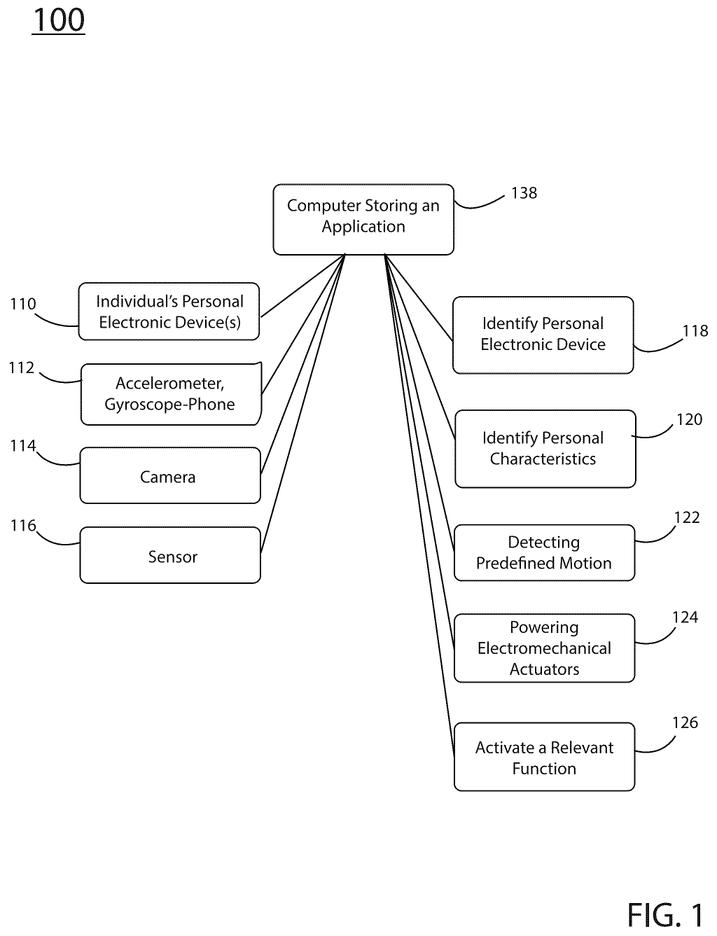

FIG. 1, 100 is a diagram of an example embodiment of the system. A central processor storing an application 138 is temporarily, wirelessly, electronically coupled to an individual's personal electronic device or devices 110. The processor receives signals from an accelerometer and/or gyroscope 112 in an electronic device. The processor storing an application 138 further receives signals from a camera 114 and/or a sensor 116. A person may perform a predefined motion in view of the camera 114 and/or sensor 116. Images from the camera 114 and/or data from the sensor 116 are received in the processor 138 and sent to the application for processing. The application is configured to identify the personal electronic device 118 and to identify characteristics of the person who possesses the electronic device 120. The person may perform a predefined motion. One skilled in the art understands that a predefined motion may be a pre-programmed motion or a motion the person performed in view of the cameras which was recorded by the processor. The application is configured to compare images and data with stored images and data to detect and confirm the predefined motion 122. Upon confirming the reenactment of the predefined motion 122, the application powers electromechanical actuator(s) 124 that in turn activate a relevant function 126.

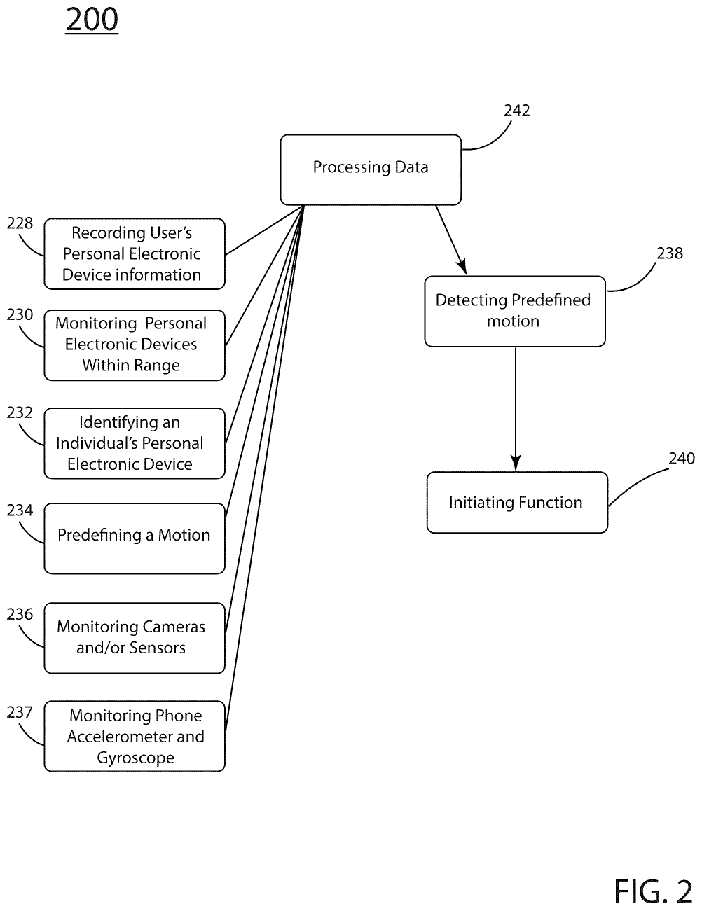

FIG. 2, 200, is a diagram of a method of using the system of FIG. 1. The method begins by recording a user's personal electronic-device information 228 and processing the personal electronic-device information to recognize the personal electronic device when it is in range of the camera and/or sensor. The method continues by monitoring personal electronic devices in range of the camera and/or sensor 230 and identifying stored personal electronic devices 232 when they are in range of the camera and/or sensor. The method proceeds by predefining a motion 234. In some embodiments, the motion is a standard motion such as raising a hand, or raising both hands. These standard motions may be performed by any individual and may be recognized by processed sensor data 242 to match the standard motion. In other embodiments, predefining a motion 234 involves the user positioning themselves in range of the camera and/or sensor and performing a motion. The data 242 of the recorded motion is processed and recorded 238. Once the motion is predefined 234, the application continues by monitoring cameras and/or sensors 236 and processing data 242 from monitored cameras and/or sensors, received in the processor and processed by the application. Monitored cameras and/or sensors engage the application when detecting a predefined motion 238. The application proceeds by initiating a function 240.

In some embodiments, the method further monitors accelerometers and gyroscopes 234 in electronic devices equipped with such features. Monitoring of sensors and cameras 230, personal electronic devices 232 accelerometers and gyroscopes 234 proceed to a step of processing data 242 to identify an individual. Once an individual has been identified, the method continues by detecting the predefined motion 238. The predefined motion data is processed to confirm that it is the same motion that was previously defined 228. The application proceeds by initiating a function 240. One skilled in the art understands that the function may be any of the functions described in the summary of the disclosure.

1. A motion-recognition system comprising:
a processing unit storing an application wirelessly coupled to at least one portable electronic device; and
at least one sensor electrically coupled to the processing unit, configured to capture an individual's body movement, and send body-movement data to the application; wherein
the application receives signals from the portable electronic device for identifying the owner of the electronic device; the application analyzes and matches the body-movement data with predefined body-movement data, and when properly matched, the application powers electronic equipment configured to perform a function.

2. The motion-recognition system of claim 1 wherein:
powered electronic equipment comprises at least one electromechanical actuator.

3. The motion-recognition system of claim 2 wherein:
the electromechanical actuator moves a catch in a lock.

4. The motion-recognition system of claim 1 wherein:
powered electronic equipment comprises at least one switch.

5. The motion-recognition system of claim 1 wherein:
the predefined motion is independent of the identified individual's body shape.

6. The motion-recognition system of claim 1 wherein:
the predefined motion is dependent on the identified individual's body shape.

7. The motion-recognition system of claim 6 wherein:
the predefined motion is dependent on the identified individual's body shape and is pre-recorded by the individual; wherein
the individual performs the body movement in range of the sensor, and the sensor data is stored in the application for matching to it upon subsequent use.

8. A motion-recognition system comprising:
a processing unit storing an application wirelessly coupled to at least one portable electronic device; and
at least one camera electrically coupled to the processing unit, configured to capture an individual's body movement and send body-movement image data to the application; wherein
the application receives signals from the portable electronic device for identifying the owner of the electronic device; the application analyzes and matches the body-movement image data with predefined body-movement image data, and when properly matched, the application powers electronic equipment configured to perform a function.

9. The motion-recognition system of claim 8 wherein:
powered electronic equipment comprises at least one electromechanical actuator.

10. The motion-recognition system of claim 9 wherein:
the electromechanical actuator moves a catch in a lock.

11. The motion-recognition system of claim 8 wherein:
powered electronic equipment comprises at least one switch.

12. The motion-recognition system of claim 8 wherein:
the predefined motion is independent of the identified individual's body shape.

13. The motion-recognition system of claim 8 wherein:
the predefined motion is dependent on the identified individual's body shape.

14. The motion-recognition system of claim 13 wherein:
the predefined motion is dependent on the identified individual's body shape and is pre-recorded by the individual; wherein
the individual performs the body movement in range of the sensor, and the sensor data is stored in the application for matching to it upon subsequent use.

15. A method of using the system of claim 1, the method comprising:
recording a known user's electronic-device information in the application; and
monitoring personal electronic devices in range of the sensor; and
identifying a recorded personal electronic device; and
defining a motion in range of the sensor; and
processing sensor data relating to the defined motion; and
recording processed sensor data relating to the defined motion; and
monitoring sensors for a defined motion; and
detecting a defined motion; and
initiating a function.

16. The method of claim 15 further comprising:
initiating the function, including engaging an electromechanical actuator.

17. The method of claim 16 wherein:
the electromechanical actuator actuates a lock.

18. The method of claim 15 further comprising:
initiating the function, including engaging a switch.

19. The method of claim 15 further comprising;
receiving signals from the identified personal electronic device accelerometer and gyroscope; and
recording accelerometer and gyroscope data when recording processed sensor data relating to the defined motion; and
monitoring sensors for recorded accelerometer and gyroscope data when monitoring sensors for a defined motion; and
detecting recorded accelerometer and gyroscope data when detecting the previously defined motion.

20. The method of claim 15 further comprising;
incorporating information from the camera of claim 8; and
combining image data from the camera with sensor data from the sensor, wherein the combined data is used to identify the personal electronic device and to detect the predefined motion.
